(19) United States
(12) Patent Application Publication
(10) Pub. No.: US 2019/0092344 A1
(43) Pub. Date: Mar. 28, 2019

(54) INFORMATION DISPLAY APPARATUS FOR VEHICLE

(71) Applicant: SUBARU CORPORATION, Tokyo (JP)

(72) Inventor: Shunsuke MAKABE, Tokyo (JP)

(21) Appl. No.: 15/987,792

(22) Filed: May 23, 2018

(30) Foreign Application Priority Data
Sep. 28, 2017 (JP) 2017-188792

(51) Int. Cl. B60W 50/14; G06F 3/0481; B60W 30/09

(52) U.S. Cl. CPC B60W 50/14; G06F 3/04817; B60W 2550/10; B60W 2050/146; B60W 30/09

(57) ABSTRACT

An information display apparatus for a vehicle includes a surrounding information acquisition unit, and a display. The surrounding information acquisition unit is configured to acquire information on a surrounding environment of the vehicle, and the display is configured to be able to display the surrounding environment and a content of a course or running of the vehicle depending on the surrounding environment. The display is capable of selectably displaying an icon that comprehensively represents the content of the course or the running of the vehicle and the surrounding environment responsible for the content of the course or the running. When the icon is selected, the display displays detailed information on the content of the course or the running of the vehicle and the surrounding environment responsible for the content of the course or the running.

### CROSS-REFERENCE TO RELATED APPLICATIONS

The present application claims priority from Japanese Patent Application No. 2017-188792 filed on Sep. 28, 2017, the entire contents of which are hereby incorporated by reference.

### BACKGROUND

### 1. Technical Field

The present invention relates to an information display apparatus for vehicle.

### 2. Related Art

In recent years, an automobile is equipped with a display apparatus. A display apparatus that enlarges and displays an obstacle which is located far away and therefore is less visible, has been disclosed, for example, in Japanese Unexamined Patent Application Publication No. 2001-071790. In addition, such a display apparatus may display a guide route for a vehicle and other information.

### SUMMARY OF THE INVENTION

An aspect of the present invention provides an information display apparatus for a vehicle including: a surrounding information acquisition unit configured to acquire information on a surrounding environment of the vehicle; and a display configured to be able to display the surrounding environment and a content of a course or running of the vehicle depending on the surrounding environment. The display is capable of selectably displaying an icon that comprehensively represents the content of the course or the running of the vehicle and the surrounding environment responsible for the content of the course or the running. When the icon is selected, the display displays detailed information on the content of the course or the running of the vehicle and the surrounding environment responsible for the content of the course or the running.

### BRIEF DESCRIPTION OF THE DRAWINGS

FIG. 1 is a schematic view illustrating an automobile and a road on which the automobile is running according to an example of the present invention;

FIG. 2 illustrates the configuration of an information display apparatus mounted in the automobile illustrated in FIG. 1;

FIG. 3 is a flowchart illustrating an exemplary process performed by an automated driving controller illustrated in FIG. 2;

FIG. 4 is a flowchart illustrating an exemplary process performed by a display controller illustrated in FIG. 2;

FIG. 5A, FIG. 5B and FIG. 5C illustrate a transition process of displaying information on the surrounding environment of the automobile illustrated in FIG. 1;

FIG. 6A and FIG. 6B illustrate a first modification of the transition process of displaying information illustrated in FIGS. 5A-5C;

FIG. 7A and FIG. 7B illustrate a second modification of the transition process of displaying information illustrated in FIGS. 5A-5C; and

FIG. 8 illustrates a modification of the transition process of displaying information where an icon indicating a previous course is additionally displayed.

### DETAILED DESCRIPTION

When types or amounts of information increase, a display apparatus may not display all the information. In particular, when an automobile is automatically driven, the display apparatus may be required to display content of control of a course and running of the automated driving, and an object to be avoided such as an obstacle and a mobile object on and around the course, to a passenger in the automobile. By this means, the passenger can recognize the motion of the automobile automatically driven, and understand the reason for the motion.

It is desirable to provide an information display apparatus capable of organizing information and displaying the organized information to the passenger.

Hereinafter, examples of the present invention will be described with reference to the drawings.

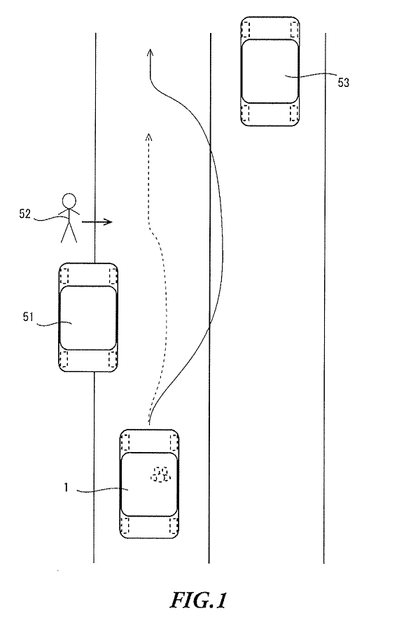

FIG. 1 is a schematic view illustrating an automobile 1 and a road on which the automobile is running according to an example of the present invention. As illustrated FIG. 1, another automobile 51 is stopped alongside the road on which the automobile 1 is running. In this case, the automobile 1 automatically driven is controlled such that the automobile 1 is steered to avoid the automobile 51 and approaches the center, and then steered to return to in the original lane, as indicated by a dashed line in FIG. 1. In addition, as illustrated in FIG. 1, there is a pedestrian 52 in front of the stopped automobile 51. The pedestrian 52 may enter the road. Meanwhile, an oncoming automobile 53 runs in the opposite direction in an oncoming lane.

In recent years, the automobile 1 is equipped with a display 14 as described later. This display 14 displays various information such as a guide route for the automobile 1. When the automobile 1 is automatically driven, the display 14 may be required to display the content of the control of the course and the running of the automated driving, and a risk factor such as an obstacle and a mobile object on and around the course. By this means, a passenger can recognize the motion of the automobile 1 automatically driven, and understand the reason for the motion. However, when types or amounts of information to be displayed by the display 14 increase, the display 14 may not display all the information. If the display 14 can display a plenty of information, the passenger cannot necessarily recognize the displayed information at sight and correctly understand all the contents of the information. The ability of understanding varies depending on the age, the physical condition and so forth of the passenger. Thus, the automobile 1 is required to organize information and display the organized information to the passenger, and also required to help the passenger understand the information.

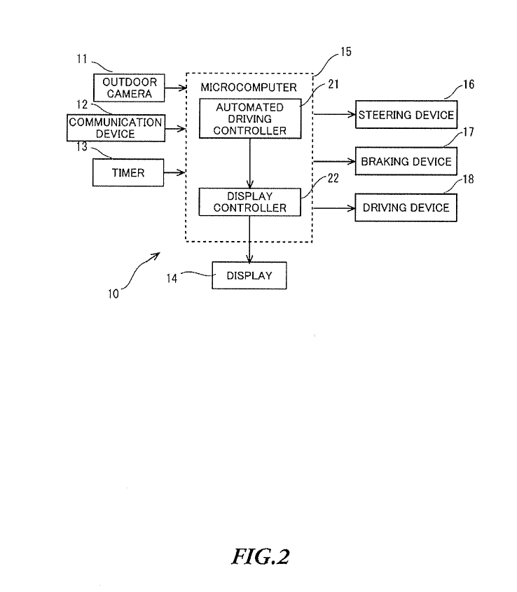

FIG. 2 illustrates the configuration of an information display apparatus 10 mounted in the automobile 1 illustrated in FIG. 1. The information display apparatus 10 illustrated in FIG. 2 includes an outdoor camera 11, a communication device 12, a timer 13, a display 14, and a microcomputer 15 to which those components are coupled. In addition, FIG. 2 illustrates a steering device 16, a braking device 17 and a driving device 18 connected to the microcomputer 15 to control the automobile 1 automatically driven. The microcomputer 15 may be provided in the automobile 1 as, for example, an ECU (electric control unit). The microcomputer 15 reads a program stored in, for example, a storage unit (not shown) and performs the program. By this means, an automated driving controller 21 and a display controller 22 are implemented by the microcomputer 15.

The outdoor camera 11 is configured to capture images of the surrounding environment of the automobile 1, for example, the road ahead. It is possible to acquire information on the surrounding environment such as the road on which the automobile 1 is running, from images captured by the outdoor camera 11. For example, an object to be avoided such as obstacle on the course may be shown in the captured image in the surrounding environment of the automobile 1.

The communication device 12 is configured to communicate with communication equipment outside the automobile 1. This communication equipment may be provided in, for example, the automobile 51, and the oncoming automobile 53. In this case, for example, the automobile 1 may communicate with the automobile 51 or 53. In addition, the communication device 12 may communicate with a base station for a commercial radio communication network. By this means, the communication device 12 can acquire information on the surrounding environment of the automobile 1.

The timer 13 is configured to measure time. The timer 13 can measure timings used for the control.

The steering device 16 controls the direction of tires of the automobile 1, based on the operation of the handle by the passenger, and therefore controls the traveling direction of the automobile 1.

The braking device 17 is configured to decrease the speed of the automobile 1, or stops the automobile 1, based on the operation of the brake by the passenger.

The driving device 18 is configured to accelerate the automobile 1 based on the operation of the accelerator by the passenger.

The automated driving controller 21 controls the running of the automobile 1 automatically driven. The automated driving controller 21 creates a scenario to control the course and the running of the automobile 1 automatically driven, depending on, for example, the surrounding environment of the automobile 1, and controls the course and the running of the automobile 1 based on the created scenario. The automated driving controller 21 controls the steering device 16, the braking device 17, and the driving device 18 to move the automobile 1 to a destination.

The display 14 is configured to display images to the passenger. With the present example, the display 14 displays images to the passenger within the visual field of the passenger. Examples of this display 14 include a head-mounted display mounted to the passenger, and a projector configured to project an image onto a windshield. In addition, with the present example, the surrounding environment, and the content of the control of the course and the running of the automobile 1 automatically driven depending on the surrounding environment are superimposed on the landscape, and displayed by the display 14 to the passenger within the visual field of the passenger.

The display controller 22 controls the display by the display 14. The display controller 22 causes the display 14 to display various information.

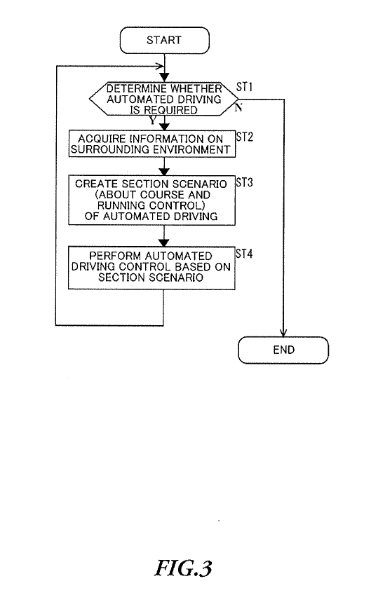

FIG. 3 is a flowchart illustrating an exemplary process performed by the automated driving controller 21 illustrated in FIG. 2. The automated driving controller 21 repeatedly performs the process illustrated in FIG. 3 while the automobile 1 is running.

In the process of the automated driving control illustrated in FIG. 3, the automated driving controller 21 first determines whether the automated driving is required (step ST1). When determining that the automated driving is not required, the automated driving controller 21 ends the process illustrated in FIG. 3. On the other hand, when determining that the automated driving is required, the automated driving controller 21 acquires information on the surrounding environment in order to acquire information on the running environment of the automobile 1 (step ST2). For example, the automated driving controller 21 acquires a captured image from the outdoor camera 11. In addition, the automated driving controller 21 acquires information on the surrounding environment from the oncoming automobile 53 by using the communication device 12.

After acquiring the information on the surrounding environment, the automated driving controller 21 creates a section scenario to control the course and the running of the automobile 1 automatically driven depending on the surrounding environment (step ST3). Here, when there is not any change in the surrounding environment, which needs to change the automated driving, the automated driving controller 21 may use the section scenario created the last time. Then, when a new obstacle is detected on the road on which the automobile 1 is running, the automated driving controller 21 creates a section scenario to control the running to bypass the obstacle. The section scenario contains steering control to cause the automobile 1 to detour and to return to the original course, and deceleration control if necessary. In addition, when it is predicted that the pedestrian 52 may suddenly appear in front of the automobile 1, the automated driving controller 21 creates a section scenario to stop the automobile 1 before the automobile 1 reaches a position at which the pedestrian 52 may suddenly appear. The section scenario contains the deceleration control to properly stop the automobile 1, and the steering control if necessary. By this means, the section scenario for the automated driving is created depending on the latest surrounding environment of the automobile 1, and updated in a timely manner. Here, for example, when the automobile 1 is automatically driven to move toward the destination, a section scenario means a sequence and the content of the control of running not for the entire route, but for a short section of, for example, several tens of meters to several hundreds of meters. For example, the content of the control to change the running state and the timing at which the control starts constitute one sequence step, and a plurality of sequence steps constitute a section scenario in general. Moreover, the automated driving controller 21 may create a plurality of section scenarios at a time. By this means, the automated driving controller 21 can separately create a section scenario to cope with an object to be avoided such as an obstacle, and a section scenario based on the guide route to the destination, and update the separated section scenarios. Moreover, it is possible to update a scenario for each of the sections by creating each of the section scenarios corresponding to the running of the automobile 1 for a short distance, and therefore to reduce a total processing load.

After creating or updating the section scenario depending on the latest surrounding environment, the automated driving controller 21 performs automated driving control based on the last section scenario (step ST4). By this means, it is possible to control the course and the running of the automobile 1.

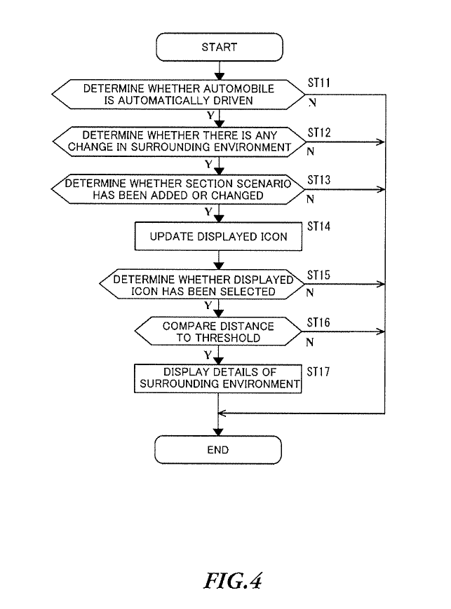

FIG. 4 is a flowchart illustrating an exemplary process performed by the display controller 22 illustrated in FIG. 2. The display controller 22 repeatedly performs the process illustrated in FIG. 4 while the automobile 1 is running.

During the process illustrated in FIG. 4, the display controller 22 first determines whether the automobile 1 is automatically driven (step ST11). When determining that the automobile 1 is not automatically driven, the display controller 22 ends the process illustrated in FIG. 4. On the other hand, when determining that the automobile 1 is automatically driven, the display controller 22 further acquires information on the surrounding environment, and determines whether there is any change in surrounding environment (step ST12). In addition, the display controller 22 acquires the section scenario for the automated driving, and determines whether the section scenario for the automated driving has been added or changed (step ST13). When determining that there is no change in the surrounding environment, or the section scenario for the automated driving has not been added or changed, the display controller 22 ends the process illustrated in FIG. 4.

On the other hand, when determining that there is any change in the surrounding environment, and the section scenario for the automated driving has been added or changed, the display controller 22 updates an icon displayed by the display 14 (step ST14). To update the information displayed by the display 14, the display controller 22 first selects the icon representing the new surrounding environment and the new section scenario, and causes the display 14 to display the selected icon. By this mean, the new icon is displayed to the passenger within the visual field of the passenger. Here, when there is a plurality of section scenarios, the display controller 22 selects the icon for each of the section scenarios, and causes the display 14 to display the selected icons. Here, the icons may be stored in a memory in the microcomputer 15 in association with the corresponding surrounding environments and section scenarios.

After updating the icon to be displayed, the display controller 22 determines whether the displayed icon has been selected (step ST15). When determining that the icon has not been selected, the display controller 22 ends the process illustrated in FIG. 4. On the other hand, when the displayed icon has been selected, the display controller 22 estimates an interval to the section scenario corresponding to the selected icon, and compares the interval to a threshold (step ST16). By analyzing, for example, a captured image, the display controller 22 can acquire a distance or a period of time from the current location of the automobile 1 to a spot or a section in which a situation represented by the selected icon occurs. The interval may be a distance or a period of time.

When determining that the interval is equal to or greater than the threshold, the display controller 22 causes the display 14 to display details of the situation, the course of the automated driving, and the content of the section scenario represented by the selected icon, (step ST17). By this means, the passenger can understand the content of the control of the running and the reason why the control is performed, based on the detailed information displayed by the display 14.

On the other hand, when determining that the interval is smaller than the threshold, the display controller 22 ends the process illustrated in FIG. 4. By this means, when the interval is not sufficient, the detailed information is not displayed.

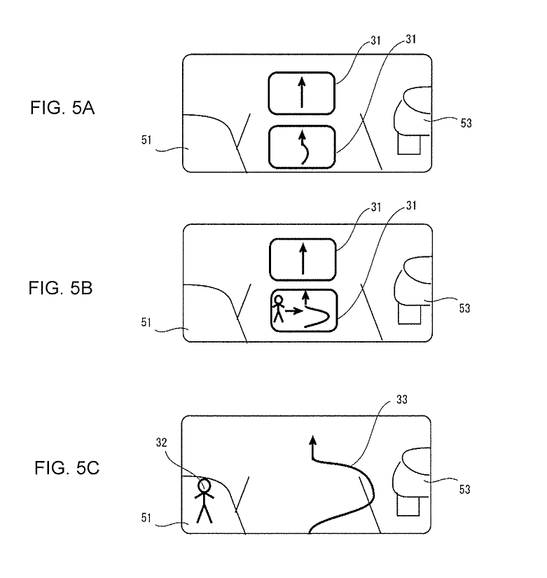

FIGS. 5A-5C illustrate a transition process of displaying information on the surrounding environment illustrated in FIG. 1. In FIG. 5A, two icons 31 are arranged one above the other in sequence in the traveling direction and displayed within the visual field of the passenger. The lower icon 31 represents to bypass the automobile 51 stopped on the road shoulder, as the course of the automated driving illustrated in the lower half of FIG. 1. The upper icon 31 represents to move the automobile 1 straight ahead after the automobile 1 has passed the automobile 51, as the course of the automated driving illustrated in the upper half of FIG. 1. In this case, the automobile 1 automatically driven is moved along the course indicated by the dashed line in FIG. 1.

After that, when it is predicted that the pedestrian 52 may cross in front of the automobile 1, based on the information on the surrounding environment acquired by the communication with, for example, the oncoming automobile 53, the course of the automated driving is changed to one indicated by the solid line in FIG. 1. In this case, the lower icon 31 indicating the course of the automated driving illustrated in the lower half of FIG. 1 is updated to represent to detour to avoid the pedestrian 52 as illustrated in FIG. 5B.

Then, when the interval to a detour route indicated by the updated lower icon 31 is equal to or greater than the threshold, the display 14 displays a FIG. 32 as the pedestrian 52 which is responsible for the detour and an actual course 33 to detour to avoid the pedestrian 52, as illustrated in FIG. 5C, based on the selection of the lower icon 31.

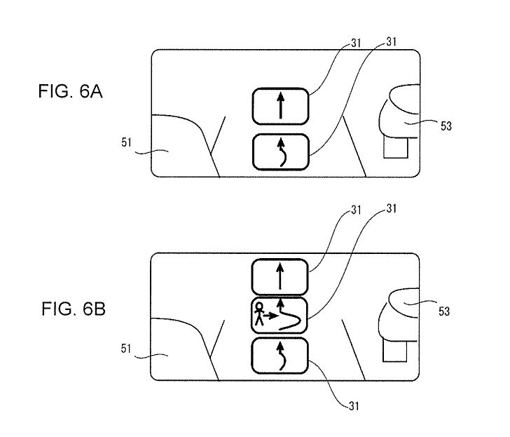

FIGS. 6A and 6B illustrate a first modification of the transition process of displaying information illustrated in FIGS. 5A-5C. In FIG. 6A, the two icons 31 which are the same as in FIG. 5A are arranged one above the other in sequence in the traveling direction and displayed within the visual field of the passenger. Then, when it is predicted that the pedestrian 52 may cross in front of the automobile 1, a third icon 31 is added between the two displayed icons 31, as illustrated in FIG. 6B. This third icon 31 represents to detour to avoid the pedestrian 52. In this case, when the interval to a detour route indicated by the added third icon 31 is equal to or greater than the threshold, the display 14 displays the FIG. 32 of the pedestrian 52 which is responsible for the detour and an actual course to detour to avoid the pedestrian 52, based on the selection of the third icon 31, in the same way as in FIG. 5C.

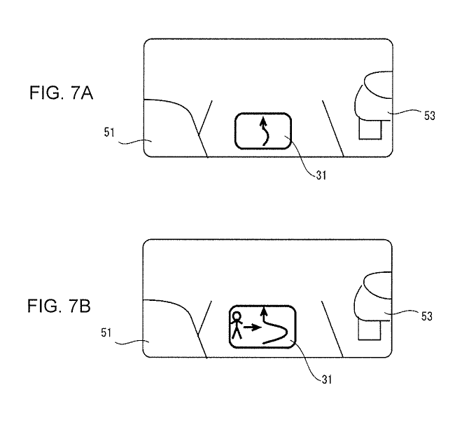

FIGS. 7A and 7B illustrate a second modification of the transition process of displaying information illustrated in FIGS. 5A-5C. In FIGS. 7A-7B, the display controller 22 causes the display 14 to display only the icon representing a section scenario created based on the surrounding environment except for the guide course. That is, in the case of FIG. 5A, only the lower icon 31 is displayed. Also, in the case of FIG. 5B, only the lower icon 31 is displayed. By this means, an icon representing the section scenario created based on the guide route is not displayed. The icon 31 is not displayed unless any situation requiring a change in the course occurs. Only the icon 31 indicating the changed course is displayed, and therefore, the passenger can understand that the course is changed depending on the surrounding environment and the automated driving is controlled accordingly, based on the presence of the displayed icon 31.

As described above, with the present example, the display 14 selectably displays the icon 31 comprehensively representing the content of the control of the course or the running of the automobile 1 automatically driven, and the surrounding environment responsible for the content of the control, or the object to be avoided on and around the course, and, when the icon 31 is selected, the display 14 displays detailed information on the content of the control of the course or the running of the automobile 1 automatically driven, and the surrounding environment responsible for the content of the control. Therefore, the passenger can comprehensively understand the motion of the automobile 1 based on the icon 31 which comprehensively represents the situation. Moreover, when the icon 31 is selected, the display 14 displays detailed information on the content of the control of the course or the running of the automobile 1 automatically driven, and the surrounding environment responsible for the content of the control. Therefore, the passenger can understand the content of the motion of the automobile 1 and the reason for the motion, if needed. In this way, by combining plurality of pieces of information such as the motion of the automobile 1, and displaying the information as one icon 31, it is possible to help the passenger understand the information. The passenger can quickly understand the motion of the automobile 1, for example, which is automatically driven.

With the present example, only when the distance or the period of time from the current location of the automobile 1 to a spot or a section in which the situation represented by the icon 31 occurs is equal to or greater than the threshold, the display 14 displays detailed information in response to the selection of the icon 31. For example, a plurality of icons 31 indicating a plurality of courses of the automated driving created by the automated driving controller 21 are arranged in sequence in the traveling direction, and the display 14 displays these icons 31 within the visual field of the passenger, and displays detailed information on only the icon 31 representing that the distance or the period of time to the current location of the automobile 1 is equal to or greater than the threshold, in response to the selection of the icon 31. By this means, the passenger can understand the situation in the vicinity of the automobile 1 firsthand. It is possible to avoid affecting the understanding of the passenger by, for example, time delay in displaying the icon 31. Moreover, the passenger can understand the surrounding environment firsthand, and therefore can correctly understand what has happened in the surrounding environment.

While the above-described examples are preferred examples of the present invention, it is to be understood that the invention is not limited to these examples. The present invention is intended to cover various modification and alteration without departing from the spirit and scope of the present invention.

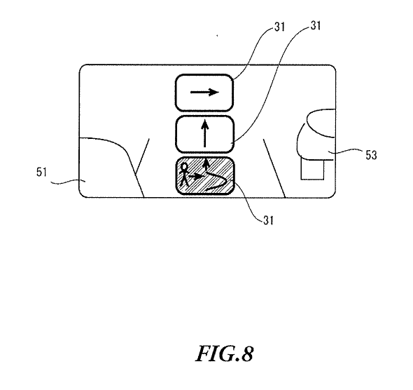

FIG. 8 illustrates a modification of the transition process of displaying information where an icon indicating a previous course is additionally displayed. In FIG. 8, the display 14 displays the icon 31 indicating the previous course of the automated driving that the automobile 1 has just passed, beneath the two icons indicating the course of the automated driving on which the automobile 1 will runs. The three icons 31 are arranged one above the other in sequence and displayed within the visual field of the passenger. Moreover, the display 14 may display information on the surrounding environment, and the course and the control of the automated driving in response to the selection of the icon 31 indicating the previous course, in the same way as in FIG. 5C. As described above, the display 14 displays the icon 31 indicating the previous course along with the icon 31 indicating the future course of the automated driving. By this means, the passenger can understand that the last motion of the automobile 1 automatically driven is a normal motion. Moreover, the display 14 displays detailed information for the icon 31 indicating the previous course of the automated driving in response to the selection of the icon 31. By this means, the passenger can understand the content of the last motion of the automobile 1 if needed. Also, the passenger can know details of the surrounding environment responsible for the motion.

With the above-described example and modifications, the display 14 displays information by using the icons 31 during the automated driving. However, this is by no means limiting. The display 14 may display information by using the icons 31 while the passenger manually drives the automobile 1.

With the above-described example and modifications, the display 14 selectably displays the content of the control of the course and the running of the automobile 1 automatically driven, and the surrounding environment responsible for the content of the control, by using the icon 31 which comprehensively represents them. In addition, the display 14 may selectably display the icon 31 which represents only the surrounding environment responsible for the content of the control. In this case, the display 14 may display detailed information for the icon 31 in response to the selection of this icon 31 only when, for example, the distance or the period of time to the current location of the automobile 1 is equal to or greater than the threshold. Then, the display 14 may display details of the content of the control of the course and the running of the automobile 1 automatically driven, along with the surrounding environment responsible for the content of the control, in response to the selection of the icon 31. Moreover, the display 14 may provide more simplified display without using the icon 31.

1. An information display apparatus for a vehicle comprising:
a surrounding information acquisition unit configured to acquire information on a surrounding environment of the vehicle; and
a display configured to be able to display the surrounding environment and a content of a course or running of the vehicle depending on the surrounding environment, wherein:
the display is capable of selectably displaying an icon that comprehensively represents the content of the course or the running of the vehicle and the surrounding environment responsible for the content of the course or the running; and
when the icon is selected, the display displays detailed information on the content of the course or the running of the vehicle and the surrounding environment responsible for the content of the course or the running.

2. The information display apparatus for vehicle according to claim 1, further comprising a distance acquisition unit configured to acquire a distance or a period of time from a current location of the vehicle to a spot or a section in which a situation represented by the icon occurs,
wherein the display displays the detailed information in response to the selection of the icon, only when the distance acquired by the distance acquisition unit is equal to or greater than a threshold.

3. The information display apparatus for vehicle according to claim 1, further comprising an automated driving controller configured to control the vehicle automatically driven, wherein:
the automated driving controller creates a scenario about control of the course and the running of the vehicle automatically driven depending on the surrounding environment;
the display selectably displays the icon which comprehensively represents a content of the control of the course or the running of the vehicle automatically driven and the surrounding environment responsible for the content of the control of the course or the running; and
when the icon is selected, the display displays detailed information on the content of the control of the course or the running of the vehicle automatically driven and the surrounding environment responsible for the content of the control of the course or the running.

4. The information display apparatus for vehicle according to claim 2, further comprising an automated driving controller configured to control the vehicle automatically driven, wherein:
the automated driving controller creates a scenario about control of the course and the running of the vehicle automatically driven depending on the surrounding environment;
the display selectably displays the icon which comprehensively represents a content of the control of the course or the running of the vehicle automatically driven and the surrounding environment responsible for the content of the control of the course or the running; and
when the icon is selected, the display displays detailed information on the content of the control of the course or the running of the vehicle automatically driven and the surrounding environment responsible for the content of the control of the course or the running.

5. The information display apparatus for vehicle according to claim 3, wherein:
the display displays a plurality of icons arranged in sequence in a traveling direction within a visual field of a passenger, the icons indicating a plurality of courses of automated driving created by the automated driving controller; and
the display displays details information for only an icon representing that a distance or a period of time to a current location of the vehicle is equal to or greater than a threshold.

6. The information display apparatus for vehicle according to claim 4, wherein:
the display displays a plurality of icons arranged in sequence in a traveling direction within a visual field of a passenger, the icons indicating a plurality of courses of automated driving created by the automated driving controller; and
the display displays details information for only an icon representing that a distance or a period of time to a current location of the vehicle is equal to or greater than a threshold.

7. The information display apparatus according to claim 3, wherein:
the display displays a plurality of icons arranged in sequence within the visual field of the passenger, each of the icons indicating a previous course of automated driving along with a future course of the automated driving, respectively; and
the display displays detailed information for the icon indicating the previous course of the automated driving, in response to the selection of the icon indicating the previous course.

8. The information display apparatus according to claim 4, wherein:
the display displays a plurality of icons arranged in sequence within the visual field of the passenger, each of the icons indicating a previous course of automated driving along with a future course of the automated driving, respectively; and
the display displays detailed information for the icon indicating the previous course of the automated driving, in response to the selection of the icon indicating the previous course.

9. The information display apparatus according to claim 5, wherein:
the display displays a plurality of icons arranged in sequence within the visual field of the passenger, each of the icons indicating a previous course of automated driving along with a future course of the automated driving, respectively; and
the display displays detailed information for the icon indicating the previous course of the automated driving, in response to the selection of the icon indicating the previous course.

10. The information display apparatus according to claim 6, wherein:
the display displays a plurality of icons arranged in sequence within the visual field of the passenger, each of the icons indicating a previous course of automated driving along with a future course of the automated driving, respectively; and
the display displays detailed information for the icon indicating the previous course of the automated driving, in response to the selection of the icon indicating the previous course.

11. The information display apparatus for vehicle according to claim 1, wherein the surrounding environment includes an obstacle, or an object to be avoided which is responsible for the content of the course or the running of the vehicle.

12. The information display apparatus for vehicle according to claim 2, wherein the surrounding environment includes an obstacle, or an object to be avoided which is responsible for the content of the course or the running of the vehicle.

13. The information display apparatus for vehicle according to claim 3, wherein the surrounding environment includes an obstacle, or an object to be avoided which is responsible for the content of the course or the running of the vehicle.

14. The information display apparatus for vehicle according to claim 4, wherein the surrounding environment includes an obstacle, or an object to be avoided which is responsible for the content of the course or the running of the vehicle.

15. The information display apparatus for vehicle according to claim 5, wherein the surrounding environment includes an obstacle, or an object to be avoided which is responsible for the content of the course or the running of the vehicle.

16. The information display apparatus for vehicle according to claim 6, wherein the surrounding environment includes an obstacle, or an object to be avoided which is responsible for the content of the course or the running of the vehicle.

17. The information display apparatus for vehicle according to claim 7, wherein the surrounding environment includes an obstacle, or an object to be avoided which is responsible for the content of the course or the running of the vehicle.

18. The information display apparatus for vehicle according to claim 8, wherein the surrounding environment includes an obstacle, or an object to be avoided which is responsible for the content of the course or the running of the vehicle.

19. The information display apparatus for vehicle according to claim 9, wherein the surrounding environment includes an obstacle, or an object to be avoided which is responsible for the content of the course or the running of the vehicle.

20. The information display apparatus for vehicle according to claim 10, wherein the surrounding environment includes an obstacle, or an object to be avoided which is responsible for the content of the course or the running of the vehicle.
